(19) United States
(12) Patent Application Publication
(10) Pub. No.: US 2009/0250522 A1
(43) Pub. Date: Oct. 8, 2009

(54) Method and Material for Manufacturing Electrically Conductive Patterns, Including Radio Frequency Identification (RFID) Antennas

(75) Inventors: Richard K. Williams, Gibsonia, PA (US); Charles R. Philip, Charlotte, NC (US)

Correspondence Address: THE WEBB LAW FIRM, P.C., 700 KOPPERS BUILDING, 436 SEVENTH AVENUE, PITTSBURGH, PA, 15219, US

(73) Assignee: K. B., INC., Gibsonia, PA (US)

(21) Appl. No.: 12/095,056

(22) PCT Filed: Dec. 11, 2006
(86) PCT No.: PCT/US06/46933

§ 371 Date: Nov. 19, 2008

Related U.S. Application Data
(60) Provisional application No. 60/749,349, filed on Dec. 9, 2005.

(51) Int. Cl. G06K 19/077; B32B 37/02

(52) U.S. Cl. 235/492; 156/234

(57) ABSTRACT

A method of making an electrically conductive patterned film (74), such as an RFID antenna, is disclosed. The method includes the steps of providing a layer of conductive metal (24) adjacent a layer of release coating (20); providing a patterned adhesive layer (400) adjacent a target substrate (42); contacting the layer of conductive metal (24) and the patterned adhesive layer (40), such that a corresponding portion (70) of the layer of conductive metal (24) contacts the patterned adhesive layer (40); and the patterned adhesive layer (40) stripping the corresponding portion (70) of the layer of conductive metal (24) from the release coating (20). The patterned adhesive layer (40) can be formed in the shape of an RFID antenna. An electrical component or a computer chip (80) can be directly applied to the layer of conductive metal (24). An RFID device, such as an RFID tag or label is also disclosed.

### BACKGROUND OF THE INVENTION

1. Field of the Invention

The present invention relates to electrically conductive patterns and, more particularly, to radio frequency identification (RFID) antennas.

2. Description of Related Art

RFID devices, such as tags and labels having RFID antennas thereon, are currently being used to track a wide variety of products and files. RFID devices are beginning to be used in a number of industries to track an item using a unique identification code throughout the entire supply chain. For example, RFID devices are being used by an increasingly large number of companies and governmental agencies in conjunction with security systems for controlling accesses and tracking inventory within the supply chain.

As described above, RFID devices are typically recognized as labels or tags. An RFID label can be attached with adhesive directly to the product or in conjunction with a pressure sensitive label. An RFID tag may also be secured to products by other attachment means, such as fasteners, strings or staples. RFID devices typically include a combination of antennas, conductive patterns or images, and analog or digital electronics, which include communications, electronics, data memory and control logic.

Conductive patterns have previously been deposited on non-conductive materials. For example, one method of producing conductive patterns or images is to mechanically or chemically etch the pattern or image into a metal film. This type of etching is exacting and expensive. Another known method includes depositing or printing conductive materials or inks onto dielectric materials. These materials and inks are typically expensive and minor manufacturing defects can result in disruptions of conductivity. Yet another method of forming an electrically conductive pattern includes selectively electroplating the top portion of a substrate that corresponds to a pattern, and separating the conductive pattern from the substrate. In this method, conductive ink, such as ink including carbon particles, is selectively placed on the conductive substrate to facilitate plating of the desired pattern. However, the process of electroplating a conductive pattern is a relatively slow and expensive process.

Accordingly, there is a need for a cost-effective process for depositing a conductive pattern onto an RFID label or tag which is both inexpensive and reliable.

### SUMMARY OF THE INVENTION

Accordingly, we have developed a method of making an electrically conductive patterned film, including the steps of providing a layer of conductive metal adjacent a layer of release coating; providing a patterned adhesive layer adjacent a target substrate; contacting the layer of conductive metal and the patterned adhesive layer, such that a corresponding portion of the layer of conductive metal contacts the patterned adhesive layer; and the patterned adhesive layer stripping the corresponding portion of the layer of conductive metal from the release coating.

We have also developed a method of making an RFID antenna, including the steps of providing a layer of conductive metal adjacent a layer of release coating; directly applying a computer chip to the layer of conductive metal; pattern applying an energy curable adhesive layer in the shape of an RFID antenna to a target substrate; laminating the energy curable adhesive layer and the layer of conductive metal, such that a corresponding portion of the layer of conductive metal contacts the energy curable adhesive layer; and the energy curable adhesive layer stripping the corresponding portion of the layer of conductive metal from the release coating.

In addition, we have developed an RFID device including a target substrate; a patterned adhesive layer adjacent the target substrate; and a corresponding portion of a layer of conductive metal adjacent the patterned adhesive layer, the corresponding portion structured and arranged for release from a layer of release coating.

### BRIEF DESCRIPTION OF THE DRAWINGS

FIG. 1 is a cross-sectional view of an intermediate structure in accordance with an embodiment of the present invention;

FIG. 2 is a cross-sectional view of a target substrate and selectively deposited patterned adhesive in accordance with an embodiment of the present invention;

FIG. 3 is a schematic diagram of a flexographic printing process used in accordance with an embodiment of the present invention;

FIG. 4 is a schematic diagram of a laminating process used in accordance with an embodiment of the present invention;

FIG. 5 is a cross-sectional view of a combined structure including a base polymeric material, a layer of release coating and a layer of conductive metal, combined with a target substrate and an adhesive layer in accordance with an embodiment of the present invention;

FIG. 6 is a cross-sectional schematic view of a curing unit and a combined structure in accordance with an embodiment of the present invention;

FIG. 7 is a schematic diagram of a curing unit and combined structure in accordance with an embodiment of the present invention;

FIG. 8 is a cross-sectional view of the separation of the combined structure into an electrically conductive patterned film and a discard portion in accordance with an embodiment of the present invention;

FIG. 9 is a schematic diagram of a stripping process used in accordance with an embodiment of the present invention;

FIG. 10 is a cross-sectional view of the separation of the conductive metal layer from the coating and base polymeric material in accordance with an embodiment of the present invention;

FIG. 11 is a cross-sectional view of the prior art separation of the metal layer from the base layer;

FIG. 12 is a cross-sectional view of a structure including a second release layer in accordance with an embodiment of the present invention;

FIG. 13 is a schematic representation of a target structure and computer chip in accordance with an embodiment of the present invention;

FIG. 14 is a cross-sectional view of a structure including a computer chip in direct contact with the conductive metal layer and a pressure-sensitive adhesive applied to the computer chip in accordance with an embodiment of the present invention;

FIG. 15 is a perspective view of a computer chip for use in accordance with the present invention; and

FIG. 16 is a cross-sectional view of a structure including a computer chip in direct contact with the conductive metal layer and a pressure-sensitive adhesive applied to the computer chip in accordance with an embodiment of the present invention.

### DESCRIPTION OF THE INVENTION

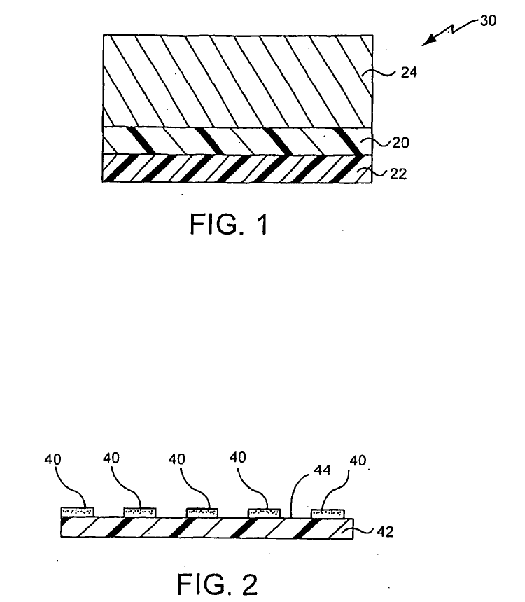

As shown in FIG. 1, a method of producing an electrically conductive patterned metal film, such as an RFID antenna, includes forming an intermediate structure 30 by applying a layer of release coating 20 to a flexible layer of base polymeric material 22 and depositing a layer of conductive metal 24 over the layer of release coating 20. In one embodiment, the base polymeric material 22 can be polyolefin, such as polyethylene or polyethylene terephthalate (PET), polyester or thermoplastic polyester, such as polycarbonate, polypropylene, biaxially oriented polypropylene (BOPP), polysulfone or a combination thereof. The layer of base polymeric material 22 can be made to any suitable thickness, such as from about 0.1 mil to about 10.0 mil, such as about 0.6 mil, or from about 10 gauge to about 100 gauge.

Referring again to FIG. 1, the layer of release coating 20 is formulated to have a greater adhesion to the base polymeric material 22 than to the conductive metal 24 that is deposited thereover. The release coating 20 can include thermally or energy cured materials. The release coating 20 can include UV curable coatings, such as UV curable silicone resin. In one embodiment, the release coating 20 can be nitrocellulose, acrylic, epoxy, polyester, polyether, ketone, polyamide, silicone, epoxy acrylate, silicone acrylate, polyester acrylate, polyether acrylate, esters of acrylic acid, mono functional acrylate resins and/or multifunctional acrylate resins. In another embodiment, the release coating 20 can be a combination of oligomeric acrylate polymers based on polyester acrylate and/or polyether acrylate resins. The release coating 20 is applied to the base polymer material 22, such as polyethylene terephthalate (PET) film, using a printing press application, such as a flexographic printing process. The release coating 20 can be applied to a thickness of between 0.025 and 5.0 lbs per 3,000 square feet of coated film, such as to a thickness of between 1.0 and 2.5 lbs per 3,000 square feet of coated film. In one embodiment, the release coating 20 is applied in a liquid state. It can be applied using standard coating methods which include, but are not limited to, flexography, gravure, roll coating, screen printing and ink train application on a lithographic press.

Referring once again to FIG. 1, the layer of conductive metal 24 is deposited over a cured layer of release coating 20. Several processes can be used to deposit the metal over the layer of release coating 20. In one embodiment, the conductive metal 24 can be deposited on the surface of the release coating 20 by commercial vacuum metallizing techniques. In another embodiment, the conductive metal 24 can be deposited on the surface of the release coating 20 by conventional metal sputtering techniques. The layer of conductive metal 24 can be made from copper, silver and/or aluminum. The thickness of the layer of conductive metal 24 depends on the metal or combination of metals used, as each specific metal or combination of metals requires a different deposition thickness to yield the necessary conductive properties. The thickness of the conductive metal 24 may be any of a wide variety of suitable thicknesses, depending on the end application for the conductive pattern. As has been recommended that for RFID antennas, the thickness may be on the order of from about 13 to about 18 microns for antennas used with 13.56 MHz systems, on the order of about 3 microns for antennas used with 900 MHz systems, and may be on the order of less than about 3 microns for antennas used with 2.45 GHz systems. In one embodiment, the layer of conductive metal 24 can be deposited to a thickness of from about 5 angstroms to about 30,000 angstroms or more. In another embodiment, the layer of conductive metal 24 can be deposited to a thickness of from about 5 angstroms to about 1,000 angstroms. The layer of conductive metal 24 can be deposited at a rate of from about 5′ to about 1,000′ per minute. However, these thicknesses are merely examples, and it will be appreciated that conductive patterns with a wide variety of other thicknesses may be employed.

Referring again to FIG. 1, in one embodiment, the optical density of the layer of conductive metal 24 may be from about 1 optical density to about 100 optical density. In another embodiment, the surface resistivity of the conductive metal 24 may be from about 0.01 OHM/square to about 1,000 OHM/square. It is recognized that the less resistance that the layer of conductive metal 24 has, the more efficient the resulting conductive pattern will be. The deposition of the metal layer can be 50 angstroms to 30,000 angstroms or more. More specifically, the metal is deposited between 200 angstroms and 1,000 angstroms. For example, the layer of conductive metal 24 can have a thickness of 250 angstroms, a 3 optical density, and a surface resistivity of 1.18 OHM/square, which yields a 0.1000 transmission of visible light.

As shown in FIG. 2, in order to transfer the layer of conductive metal 24 from the intermediate structure 30, as shown in FIG. 1, onto a desired substrate, an adhesive layer 40 is applied to a target substrate 42 in a selective pattern. In one embodiment, the selective pattern can be in the form of an RFID antenna. In another embodiment, the selective pattern can be in the form of a reverse pattern of an RFID antenna. Although the adhesive layer 40 is not conductive, it is printed onto the target substrate 42 in the pattern of a conductive pathway. In one embodiment, the adhesive layer 40 can include energy curable acrylate resins, esters of acrylic acid, mono functional acrylate resins and/or multifunctional acrylate resins. In another embodiment, the adhesive layer can include a combination of oligomeric acrylate polymers based from polyester acrylate and/or polyether acrylate resins. The adhesive layer 40 can be deposited onto a surface 44 of the target substrate 42 to a thickness of from about 0.05 mil to about 5 mil. The adhesive layer 40 can be water based, solvent based or a solid layer.

Referring again to FIG. 2, the target substrate 42 can include any material suitable for forming an RFID tag or label. In one embodiment, the target substrate 42 can include a clear polymeric material, such as polyester, PET, polypropylene, polyolefin, polycarbonate and/or polysulfone. In another embodiment, the target substrate 42 can include paper, film, board, label and/or tag stock. The target substrate 42 can be substantially deformable, such that it may be passed through rolls of a printing press, as will be described herein.

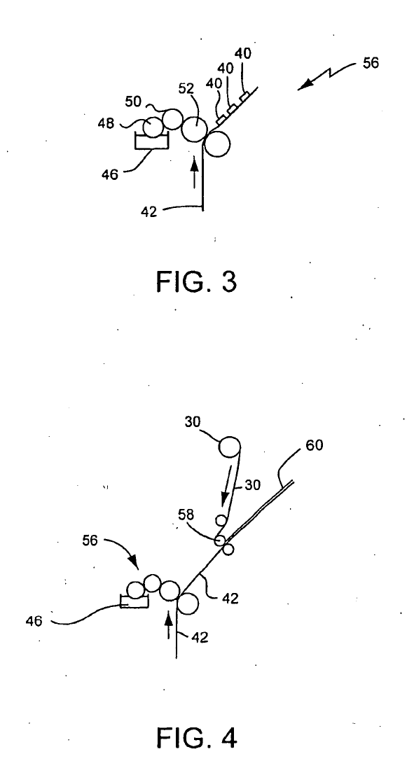

As shown in FIG. 3, the adhesive layer 40 can be applied to the target substrate 42 by a flexographic printing process 56. In this embodiment, a fountain roll 48 rotates in an adhesive reservoir 46 to pick up the adhesive for transfer to an anilox roll 50. The anilox roll 50 includes a plurality of engraved cells for supplying the adhesive to a plate cylinder 52. The target substrate 42 is passed between the plate cylinder 52 and an impression cylinder 54. The surface of the plate cylinder 52 picks up adhesive from the anilox roll 50 and transfers it to the target substrate 42. The impression cylinder 54 supports the target substrate 42 as it contacts the plate cylinder 52 to allow the surface of the target substrate 42 to receive adhesive in a precise conductive pathway pattern. In another embodiment, adhesive can be applied to the target substrate by other conventional means, such as screen printing, gravure printing, offset printing or letterpress printing, digital, ink jet, lithographic, rotary screen, flat screen or pad printing, and can be applied in roll-to-roll applications or sheet feed applications.

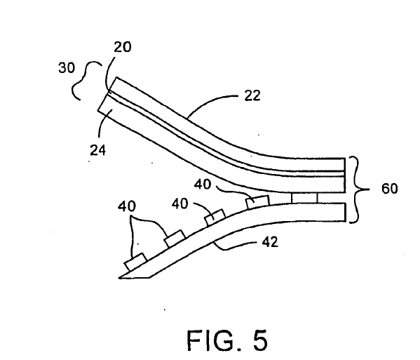

As shown in FIG. 4, once the adhesive reservoir 46 is applied to the target substrate 42, the target substrate 42 is combined or laminated to the intermediate structure 30, as shown in FIG. 1. The intermediate structure 30 and the target substrate 42 pass through a nip roller 58, wherein the adhesive reservoir 46 of the target substrate 42 contacts the layer of conductive metal (shown in FIG. 1 as numeral 24) of the intermediate structure 30. A resulting combined structure 60 is shown in FIG. 5, wherein the intermediate structure 30 including the base polymeric material 22, the layer of release coating 20 and the layer of conductive metal 24, is combined with the target substrate 42 and adhesive layer 40.

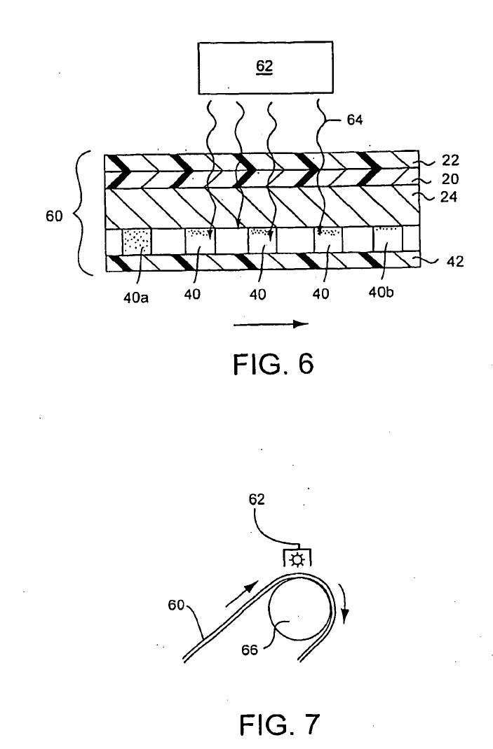

As shown in FIGS. 6 and 7, the combined structure 60 can be subsequently passed through a conventional curing unit 62 to dry or cure the adhesive layer 40 by passing energy waves 64 into the combined structure. In one embodiment, the curing unit 62 can be a convection oven, an ultra-violet (UV) curing lamp, an electron beam (EB) curing unit or other conventional unit(s) designed to cure energy curable adhesives. In one embodiment, the combined structure 60 is passed over a roller 66 in the direction shown as the combined structure 60 is passed through the curing unit 62. As the combined structure 60 is directed through the curing unit 62, energy waves 64 penetrate the base polymeric material 22, the layer of release coating 20 and the layer of conductive metal 24, and pass into the adhesive layer 40 supported by the target substrate 42. As the combined structure 60 passes through the curing unit 62, the uncured portions 40a of the adhesive layer 40 become cured portions 40b. It is also anticipated herein that the combined structure 60 may pass through the curing unit 62 in an inverted position such that the target substrate 42 is oriented adjacent the curing unit 62.

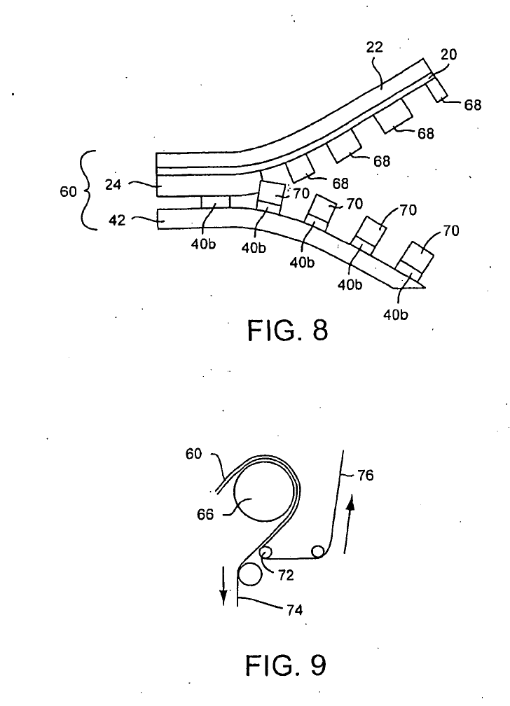

As shown in FIGS. 8 and 9, once the combined structure 60 has been cured, the combined structure 60 passes over the roller 66 and is subsequently fed through stripping roll 72. As the combined structure passes through a stripping roll 72, the base polymeric material 22, the layer of release coating 20, and non-corresponding portions 68 of the layer of conductive metal 24, collectively a discard portion 76, are removed from the target substrate 42 and the cured adhesive layer 40b. Only corresponding portions 70 of the layer of conductive metal 24 that contact the cured adhesive layer 40b remain in layered association with the target substrate 42, collectively an electrically conductive patterned film 74. The electrically conductive patterned film 74 includes pathways of conductive metal that correspond to the pre-selected shape of the adhesive layer 40. In one embodiment, the electrically conductive patterned film 74 is an electrical component, such as an antenna for an RFID device, such as an RFID tag or label. In another embodiment, the electrically conductive patterned film 74 is a computer chip or a portion of a computer chip. In yet another embodiment, the electrically conductive patterned film 74 is a circuit cable or printed circuit board. Such cables and circuit boards often require fine resolution and flexible arrays of conductive elements that are mounted on a plastic or flexible substrate.

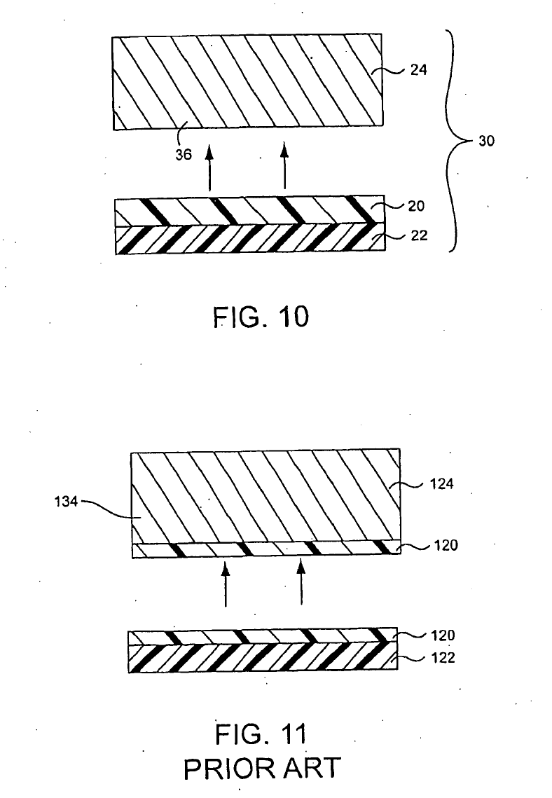

As shown in FIG. 10, one of the performance characteristics of the release coating 20 of the intermediate structure 30 is that it must stay intact with the base polymeric material 22 during the releasing process and not transfer with the corresponding portions 70 of the layer of conductive metal 24.

As shown in FIG. 11, conventional release liners 120 have previously been used in foil decoration and foil transfer processes. However, during the releasing process, the traditional release liner 120 is split between a metal layer 124 and a base layer 122. This splitting effect of the release liner 120 causes a non-conductive coating, i.e., a portion of the release liner 120 to transfer with the metal layer 124, thereby rendering a surface 134 non-conductive. While this process is effective for other applications utilizing foil transfer techniques, it is not suitable for producing conductive metallized films or electrically conductive patterns.

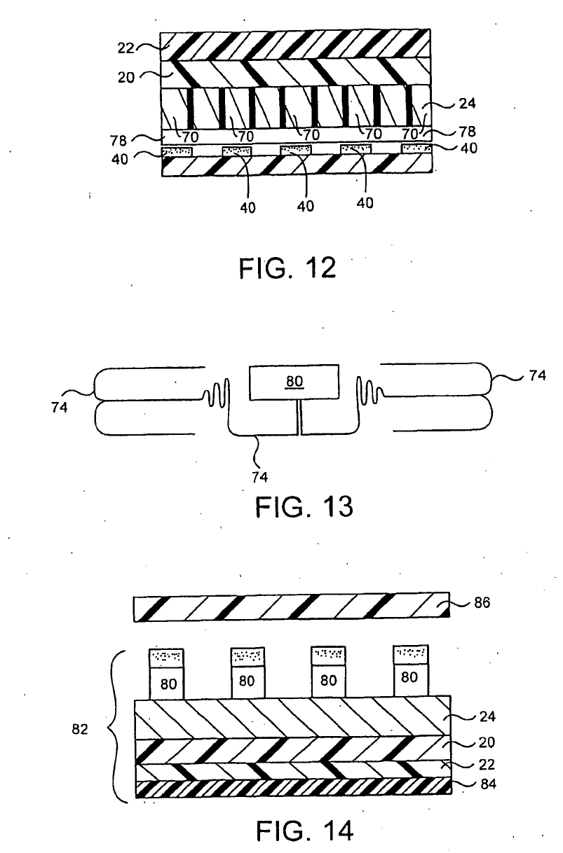

Accordingly, as shown in FIG. 12, it is understood that some adhesives 40 may not have the necessary adhesion to filly pull the corresponding portions 70 of the layer of conductive metal 24 from the release coating 20 adjacent the layer of base polymeric material 22. In one embodiment, a layer of primer 78 is applied to the surface of the layer of conductive metal 24 to enhance the adhesion of the raw metal surface to the adhesive 40. The primer can include any acrylic, polyester, polyamide, epoxy or any other resins suited to enhance adhesion of coatings to metal surfaces. In one embodiment, the primer can be deposited on the surface of the conductive metal 24 to a thickness of from about 0.05 mil to about 5 mil.

In one embodiment, as shown in FIG. 13, the electrically conductive patterned film 74 of the present invention can be electrically coupled to a computer chip 80. The electrically conductive patterned film 74 can be joined to the computer chip 80, or other electrical component through any conventional process, such as soldering, conductive adhesives or conductive straps. In one embodiment, the electrically conductive patterned film 74 can be fashioned and subsequently joined with the computer chip 80 or other electrical component. However, in another embodiment, as shown in FIG. 14, it may be desirable to transfer the computer chip 80 or electrical component to the layer of conductive metal 24 prior to applying the energy curable adhesive layer 40.

As shown in FIG. 14, the computer chip 80 or electrical component can be directly applied to the layer of conductive metal in a registered pattern using the strap method of insertion. A pressure sensitive adhesive layer 40 can then be applied over the computer chip 80 or electrical component, disposed on the layer of conductive metal 24, layer of release coating 20, and base polymeric material 22, in the shape of the desired conductive pattern. This composite structure 82 can then be wound onto a second release liner 84 and later dispensed onto a target substrate 86 using applied pressure, resulting in a complete RFID tag being dispensed in the shape of the printed adhesive as illustrated in FIG. 13.

The soldering, welding or connection with a conductive adhesive or conductive strap, between the electrically conductive patterned film 74 and the computer chip 80 or electrical component, may occur before removal of the electrically conductive patterned film 74 from the release coatings 20, 84, or alternatively, after the removal. It will be appreciated that the electrically conductive patterned film 74 be a separate article requiring no connection to an electrical component. For example, the electrically conductive patterned film 74 may be used as a decorative or other visually distinctive item.

In another embodiment, it may be advantageous to allow the release coating to completely release with the corresponding portions of the layer of conductive metal to protect the transferred pattern from scratching and oxidation In this embodiment, the release coating completely releases with the corresponding portions of the layer of conductive metal, and a computer chip can be placed on the release coating by a direct chip placement method.

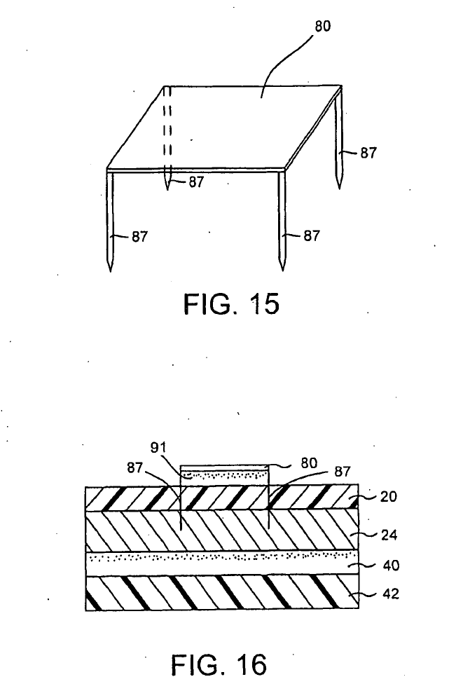

As shown in FIGS. 15-16, a direct chip placement method typically involves positioning a computer chip 80, having conductive prongs or pins 87 attached to the conductive leads of the computer chip 80 and extend downwards from the computer chip 80, between the leads of a conductive antenna. In one embodiment, as shown in FIG. 16, the conductive prongs or pins 87 may be positioned to penetrate the release coating 20 and the layer of conductive metal 24 positioned adjacent the adhesive layer 40 and target substrate 42. In one embodiment, the chip 80 may be held in place with a second adhesive 91, or may be attached to the target substrate by heat to melt a portion of the target substrate onto the computer chip. Leads of the computer chip can be positioned to penetrate the release coating 20 and make contact with the layer of conductive metal 24.

The present invention has been described with reference to the preferred embodiments. Modifications, combinations and alterations will occur to others upon reading the preceding detailed description. It is intended that the invention be construed as including all such modifications, combinations and alterations.

1. A method of making an electrically conductive patterned film (74), comprising the steps of:
providing a layer of conductive metal (24) adjacent a layer of release coating (20);
providing a patterned adhesive layer (40) adjacent a target substrate (42);
contacting the layer of conductive metal (24) and the patterned adhesive layer (40), such that a corresponding portion (70) of the layer of conductive metal (24) contacts the patterned adhesive layer (40); and
utilizing the patterned adhesive layer (40) to strip the corresponding portion (70) of the layer of conductive metal (24) from the release coating (20).

2. The method of claim 1, wherein the electrically conductive patterned film (74) is an RFID antenna.

3. The method of claim 1, wherein the layer of conductive metal (24) comprises at least one of copper, silver or aluminum.

4. The method of claim 1, wherein the layer of conductive metal (24) has a thickness of from about 5 angstroms to about 1,000 angstroms.

5. The method of claim 1, wherein the layer of release coating (20) comprises at least one of nitrocellulose, acrylic, epoxy, polyester, polyether, ketone, polyamide, silicone, epoxy acrylate, silicone acrylate, polyester acrylate, polyether acrylate, esters of acrylic acid, mono functional acrylate resins, multifunctional acrylate resins or combinations of oligomeric acrylate polymers based on polyester acrylate or polyether acrylate resins.

6. The method of claim 1, wherein the layer of release coating (20) is applied to a thickness of between 0.025 and 5.0 lbs per 3,000 square feet.

7. The method of claim 1, further comprising a layer of base polymeric material (22) adjacent the layer of release coating (20).

8. The method of claim 7, wherein the layer of release coating (20) has greater adhesion to the layer of base polymeric material (22) than to the layer of conductive metal (24).

9. The method of claim 7, wherein the layer of base polymeric material (22) comprises at least one of polyolefin, polyethylene, PET, polyester, thermoplastic polyester, polycarbonate, polypropylene, biaxially oriented polypropylene (BOPP), polysulfone or a combination thereof.

10. The method of claim 1, wherein the patterned adhesive layer (40) is in the pattern of a conductive pathway.

11. The method of claim 1, wherein the patterned adhesive layer (40) is in the pattern of an RFID antenna.

12. The method of claim 1, wherein the patterned adhesive layer (40) comprises at least one of energy curable acrylate resins, esters of acrylic acid, mono functional acrylate resins, multifunctional acrylate resins, oligomeric acrylate polymers based from polyester acrylate or polyether acrylate resins.

13. The method of claim 1, wherein the patterned adhesive layer (40) comprises a pressure-sensitive adhesive.

14. The method of claim 1, wherein the target substrate (42) comprises an RFID tag or label.

15. The method of claim 1, wherein the target substrate (42) comprises at least one of polyester, PET, polypropylene, polyolefin, polycarbonate or polysulfone.

16. The method of claim 1, further comprising the step of curing the patterned adhesive layer.

17. The method of claim 16, wherein the step of curing comprises curing by at least one of a convection oven, an ultra-violet curing lamp or an electron beam curing unit.

18. The method of claim 1, further comprising the steps of:
providing an electrical component (80) adjacent the layer of conductive metal (24); and
contacting the electrical component (80) and the patterned adhesive layer (40).

19. The method of claim 18, wherein the electrical component (80) is a computer chip.

20. A method of making an RFID antenna, comprising the steps of:
providing a layer of conductive metal (24) adjacent a layer of release coating (20);
directly applying an electrical component (80) to the layer of conductive metal (24);
pattern applying an energy curable adhesive layer (40) in the shape of an RFID antenna to a target substrate (42);
laminating the energy curable adhesive layer (40) and the layer of conductive metal (24), such that a corresponding portion (70) of the layer of conductive metal (24) contacts the energy curable adhesive layer (40); and
the energy curable adhesive layer (40) stripping the corresponding portion (70) of the layer of conductive metal (24) from the release coating (20).

21. The method of claim 20, wherein the electrical component (80) is a computer chip.

22. The method of claim 20, wherein the corresponding portion (70) of the layer of conductive metal (24) is in the shape of an RFID antenna.

23. An RFID device comprising:
a target substrate (42);
a patterned adhesive layer (40) adjacent the target substrate (42); and
a corresponding portion (70) of a layer of conductive metal (24) adjacent the patterned adhesive layer (40), the corresponding portion (70) structured and arranged for release from a layer of release coating (20).

24. The RFID antenna of claim 23, wherein the RFID device is a tag or label.

25. A method of making an electrically conductive patterned film (74), comprising:
providing a layer of conductive metal (24) adjacent a layer of release coating (20);
providing an adhesive layer (40) adjacent a target substrate (42);
contacting the layer of conductive metal (24) and the adhesive layer (40), such that a corresponding portion (70) of the layer of conductive metal (24) contacts the adhesive layer (40); and
separating the corresponding portion (70) of the layer of conductive metal (24) from the release coating (20).

26. The method of claim 25, wherein the electrically conductive patterned film (74) is an RFID antenna.

27. A method of making an RFID antenna, comprising:
providing a layer of conductive metal (24) adjacent a layer of release coating (20);
directly applying an electrical component (80) to the layer of conductive metal (24);
applying an energy curable adhesive layer (40) in the shape of an RFID antenna to a target substrate (42);
laminating the energy curable adhesive layer (40) and the layer of conductive metal (24), such that a corresponding portion (70) of the layer of conductive metal (24) contacts the energy curable adhesive layer (40); and
stripping the corresponding portion (70) of the layer of conductive metal (24) from the release coating (20).

28. The method of claim 27, wherein the electrical component (80) is a computer chip.

29. An RFID device, comprising:
a target substrate (42);
an adhesive layer (40) adjacent the target substrate (42); and
a corresponding portion (70) of a layer of conductive metal (24) adjacent the adhesive layer (40), the corresponding portion (70) structured and arranged for release from a layer of release coating (20).
